(19) United States
(12) Patent Application Publication
(10) Pub. No.: US 2020/0295654 A1
(43) Pub. Date: Sep. 17, 2020

(54) Plug-and-play realization of the virtual infinite capacitors

(71) Applicant: TECHNOLOGY INNOVATION MOMENTUM FUND (ISRAEL) LIMITED PARTNERSHIP, Tel Aviv (IL)

(72) Inventors: George Weiss, Rishon Lezion (IL); Jun Lin, Tel Aviv (IL)

(21) Appl. No.: 16/652,421

(22) PCT Filed: Oct. 8, 2018
(86) PCT No.: PCT/IB2018/057774

§ 371 Date: Mar. 31, 2020

Related U.S. Application Data
(60) Provisional application No. 62/569,625, filed on Oct. 9, 2017.

(51) Int. Cl. H02M 3/04; H02M 1/42

(52) U.S. Cl. CPC H02M 3/04; H02M 2001/0003; H02M 1/4208

(57) ABSTRACT

Apparatus (22, 90) for controlling DC voltage on a bus (26) includes a switched power converter (32), including a pair of terminals (31) for connection between the bus and a ground (28), a buffering capacitor (48), and switching circuitry (36) configured to control a voltage between the terminals while a charge on the buffering capacitor varies over a predefined range in response to a current flowing through the terminals. A control circuit (50, 98) is coupled to monitor the voltage between the terminals, the current, and a voltage on the buffering capacitor, and is configured to adjust the voltage between the terminals by controlling the switching circuitry in response to changes in the monitored voltages and current so that the terminal voltage is maintained at a reference voltage value, which can be adjusted adaptively so as to converge to the equilibrium voltage of the DC bus. Consequently, the apparatus need have only two terminals, and hence is easy to install.

### CROSS-REFERENCE TO RELATED APPLICATION

This application claims the benefit of U.S. Provisional Patent Application 62/569,625, filed Oct. 9, 2017, which is incorporated herein by reference.

### FIELD OF THE INVENTION

The present invention relates generally to electrical circuits and devices, and particularly to DC voltage filtering.

### BACKGROUND

When a variable power source supplies a load with DC voltage, the voltage across the load tends to fluctuate. The traditional way to suppress such fluctuations is to connect a large capacitor, typically an electrolytic capacitor or a supercapacitor, in parallel with the load. Such filtering capacitors are commonly encountered, for example, on the DC bus in photovoltaic systems, wind power generators, sub-modules of modular multilevel converters (MMC), electric vehicles, power factor compensators (PFC), uninterruptible power supplies, and power supplies for flicker-free LED lighting. Large capacitors of this sort, however, are bulky, expensive and have a short working life.

A number of alternative solutions have been proposed to suppress voltage fluctuations without a large filter capacitor. For example, PCT International Publication WO 2015/019344, whose disclosure is incorporated herein by reference, describes a virtual infinite capacitor (VIC)—a switched power circuit containing switches, an inductor, and two small capacitors, including a charge buffering capacitor. Within a designated normal operating range, the VIC emulates the behavior of very large capacitors by maintaining a constant voltage notwithstanding changes in the charge on the buffering capacitor. The VIC is thus able to emulate large capacitors using smaller, cheaper, and more reliable ceramic or film capacitors together with suitable electronic circuitry.

### SUMMARY

Embodiments of the present invention that are described hereinbelow provide improved circuits and methods for DC voltage filtering.

There is therefore provided, in accordance with an embodiment of the invention, apparatus for controlling DC voltage on a bus, which includes a switched power converter, including a pair of terminals for connection between the bus and a ground, a buffering capacitor, and switching circuitry coupled between the buffering capacitor and the terminals and configured to control a voltage between the terminals while a charge on the buffering capacitor varies over a predefined range in response to a current flowing through the terminals. A control circuit is coupled to monitor the voltage between the terminals, the current, and a voltage on the buffering capacitor, and is configured to adjust the voltage between the terminals by controlling the switching circuitry in response to changes in the monitored voltages and current so that the terminal voltage is maintained at a reference voltage value.

In the disclosed embodiments, the switched power circuit includes a filtering capacitor coupled between the terminals, and the switching circuitry includes diodes and switches, which are configured as a reversible buck converter circuit.

In some embodiments, the control circuit is configured to control the switching circuitry by applying a state machine model including a charging state, in which the current flowing through the terminals, after conversion by the power converter, charges the buffering capacitor, a normal operating state, in which the switching circuitry is controlled to charge and discharge the buffering capacitor while maintaining the voltage between the terminals at the reference voltage value, and a protection state, in which the switching circuitry is opened to prevent overcharging of the buffering capacitor. Typically, the state machine model includes a hysteresis in levels of the charge on the buffering capacitor that cause transitions between the states.

In some embodiments, the control circuit is configured to control the switching circuitry so as to maintain the charge on the buffering capacitor within the predefined range. In the disclosed embodiments, the control circuit is configured to adjust the reference voltage value responsively to changes in the buffer voltage so as to maintain the charge on the buffering capacitor within the predefined range. In one embodiment, the control circuit includes a voltage sensor and a low-pass filter, which couples the voltage sensor to measure the buffer voltage on the buffering capacitor while filtering out of the measured buffer voltage variations above a predefined cutoff frequency, and the control circuit is configured to adjust the reference voltage value responsively to the measured, filtered buffer voltage.

Additionally or alternatively, the control circuit is configured to adjust the reference voltage value by applying an asymmetric backlash function to the changes in the voltage on the buffering capacitor. In one embodiment, the control circuit is configured to modify a width of the asymmetric backlash function responsively to a swing range of the changes in the buffer voltage.

There is also provided, in accordance with an embodiment of the invention, a method for controlling DC voltage on a bus, which includes coupling a pair of terminals of a switched power converter between the bus and a ground. The switched power converter includes a buffering capacitor and switching circuitry coupled between the buffering capacitor and the terminals and configured to maintain a voltage between the terminals at a reference voltage value while a charge on the buffering capacitor varies over a predefined range in response to a current flowing through the terminals. The voltage between the terminals and the current flowing through the terminals are monitored, and the voltage between the terminals is adjusted by controlling the switching circuitry in response to changes in the monitored voltage and current so that the voltage is maintained at the reference voltage value.

The present invention will be more fully understood from the following detailed description of the embodiments thereof, taken together with the drawings in which:

### BRIEF DESCRIPTION OF THE DRAWINGS

FIG. 1 is an electrical circuit diagram that schematically illustrates a DC power system with a plug-and-play virtual infinite capacitor (PnP VIC), in accordance with an embodiment of the invention;

FIG. 2 is an electrical schematic diagram showing details of a PnP VIC, in accordance with an embodiment of the invention;

FIG. 3A is a plot of terminal voltage against accumulated electric charge that schematically illustrates operating ranges of a PnP VIC, in accordance with an embodiment of the invention;

FIG. 3B is a state diagram that schematically illustrates a method of operation of a state machine part of a PnP VIC controller, in accordance with an embodiment of the invention;

FIG. 4 is a block diagram that schematically illustrates a control circuit in a PnP VIC, in accordance with an embodiment of the invention;

FIG. 5 is a block diagram that schematically illustrates another control circuit in a PnP VIC, in accordance with another embodiment of the invention; and

FIG. 6 is a voltage to voltage plot that schematically illustrates a backlash-based method for controlling a digital control block in the circuit of FIG. 5, in accordance with an embodiment of the invention.

### DETAILED DESCRIPTION OF EMBODIMENTS

### Overview

The VICs described in the above-mentioned PCT International Publication WO 2015/019344 suffer from a lack of flexibility: The buffering circuit that is used in the VIC to absorb voltage variations must be integrated tightly with the host system as a built-in module, in order to ensure effective charge control. For this purpose, the source-side converter must generally be modified to allow the charge controller of the VIC access to the voltage regulator of the power source. This closely-coupled solution is ineffective for distributed systems, such as DC power grids, where devices are not in the same geographic location. It is generally unsuitable for use on the DC bus of an existing power electronic system in cases in which a user would like to add or install a VIC without tampering with the control circuits of the existing system.

Embodiments of the present invention, as described herein, add “plug-and-play” capability to the VIC, meaning that the VIC can be packaged and deployed in a wide range of systems as an independent module. The plug-and-play (PnP) VIC need have only two terminals, like a conventional capacitor, and need not “know” in advance the stabilized terminal voltage, i.e., the equilibrium voltage of the (unknown) DC bus to which it is to be connected. The reference voltage of the PnP VIC is adjusted automatically so that it will converge to the equilibrium voltage of the DC bus (i.e., the average DC bus voltage at which current supply and current demand of all the devices connected to the DC bus are equal). For this purpose, a control circuit monitors the charge on the buffering capacitor of the VIC, on the basis of the voltage on the buffering capacitor, and adjusts the reference voltage when the charge approaches either end of its normal operating range.

In one embodiment, the reference voltage Vᵣ is generated based on the average value of the voltage on the buffering capacitor V_{S} over a recent time interval, measured via a high-order low-pass filter (LPF). The characteristics of this LPF are chosen carefully to ensure sharp separation between the high frequency range in which ripple occurs and the low frequency range in which power variations occur on the DC bus.

In an alternative embodiment, the reference voltage Vᵣ is derived from an asymmetric backlash, which is applied directly to the buffering capacitor voltage V_{S}.

In both embodiments, the output impedance of the plug-and-play VIC behaves at both very low and very high frequencies of voltage variation as though the VIC was a small capacitor. In the intermediate range of frequencies, where ripple current is expected, however, for example between 50 Hz and 1000 Hz, the output impedance of the VIC is very small (and ideally zero), thus emulating a very large capacitor. When these criteria are satisfied, the VIC effectively eliminates voltage ripple on the DC bus to which it is connected. No further connection is required between the PnP VIC and the DC power supply, other than the pair of terminals of the PnP VIC that are connected to the DC bus.

### System Description

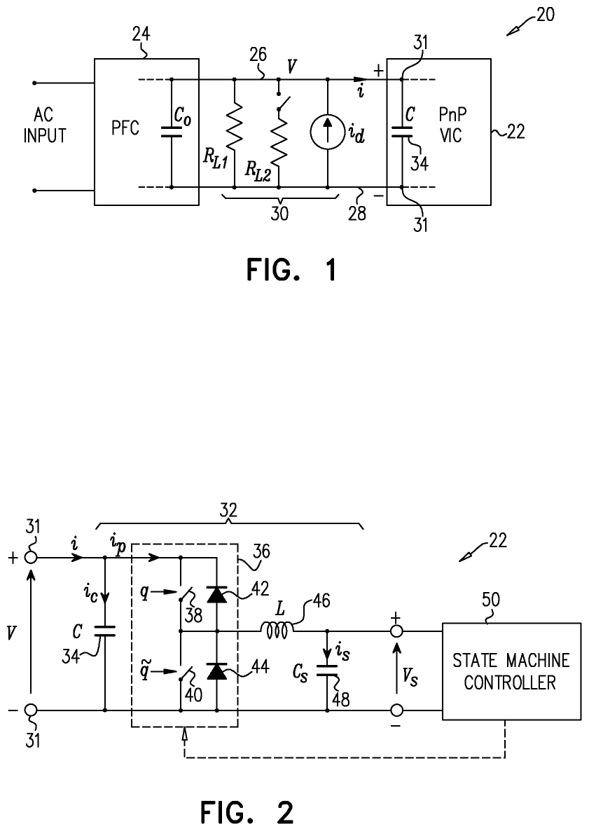

FIG. 1 is an electric circuit diagram that schematically illustrates a DC power system 20 with a plug-and-play virtual infinite capacitor (PnP VIC) 22, in accordance with an embodiment of the invention. This figure is intended to show an example application of PnP VIC 22, which may similarly be used in other sorts of systems in which DC power is generated and/or consumed.

In the pictured example, a DC power supply 24 receives AC domestic grid input and generates a desired DC voltage on a bus 26. Power supply 24 provides power factor correction (PFC), as is known in the art, and has a small output capacitance Co. A variety of loads 30 can be coupled between bus 26 and a ground 28, including (in this example) a fixed resistive load R_{L1}, a switched resistive load R_{L2}, and a nonlinear load represented as a current source i_{d}. Power supply 24 outputs a substantial ripple on bus 26 at the AC lines frequency and harmonics thereof, which is exacerbated by the effects of the nonlinear load. In systems that are known in the art, a large electrolytic capacitor could be coupled between bus 26 and ground 28 (either as a part of power supply 24 or as a separate unit) in order to filter the high-frequency ripple.

In the present embodiment, however, PnP VIC 22 alleviates the need for a large filter capacitor. PnP VIC 22 comprises a pair of terminals 31, which are connected respectively to bus 26 and ground 28, with only a small filtering capacitor 34 between the terminals. Switched power and control circuits in the PnP VIC, as shown in the figures that follow, maintain the voltage V between terminals 31 at a reference voltage value Vᵣ, while substantially eliminating the ripple on bus 26. PnP VIC 22 is designed so that other than terminals 31, there is no need for any further connection between the PnP VIC and power supply 24 or any other elements of system 20.

FIG. 2 is an electrical schematic diagram showing details of PnP VIC 22, in accordance with an embodiment of the invention. PnP VIC 22 comprises a switched power converter 32 and a control circuit 50. Switched power converter 32 comprises filtering capacitor (C) 34, a buffering capacitor (C_{S}) 48, and switching circuitry 36, which is coupled between buffering capacitor 48 and terminals 31. Switching circuitry 36 in this example is configured as a reversible buck converter, although switched power converter 32 may alternatively comprise, mutatis mutandis, other sorts of DC/DC conversion circuits that are known in the art. Thus, as shown in FIG. 2, switching circuitry 36 comprises a pair of power switches 38 and 40, comprising suitable FET devices, for example, which are (fixedly) connected in parallel with a pair of diodes 42 and 44. An inductor (L) 46 couples switching circuitry 36 to buffering capacitor 48.

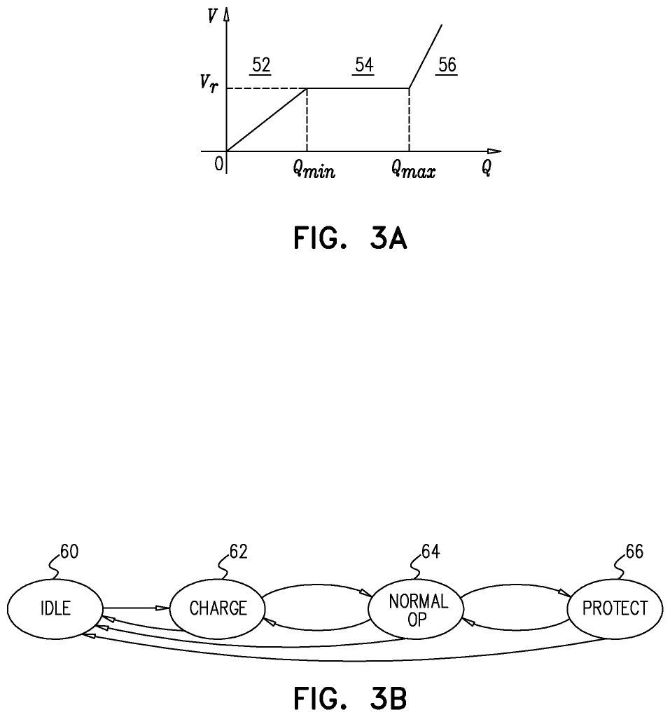

Further details of the design and operation of switched power circuit 32 are described in the above-mentioned PCT International Publication WO 2015/019344, particularly in FIG. 3 and in the accompanying description in paragraphs 00028-00040. Alternatively, the principles of the present invention may be implemented using other sorts of VIC designs, i.e., other sorts of switched power converters that are capable of maintaining a constant voltage between terminals 31 notwithstanding changes in the charge on buffering capacitor 48 over a suitable charge range, which depends on the application requirements and detailed circuit design. Such variant designs will be apparent to the person of ordinary skill in the art after reading the present description, along with PCT International Publication WO 2015/019344, and are considered to be within the scope of the present invention.

Control circuit 50 monitors the voltage V between terminals 31, the voltage V_{S} on buffering capacitor 48, and the current i flowing through the terminals, and controls switching circuitry 36 based on these monitored values so as to maintain V at the desired reference voltage value Vᵣ. Specifically, control circuit 50 outputs binary control signals q and q, which open and close switches 38 and 40, respectively. The timing of opening and closing the switches defines a pattern of pulse-width modulation (PWM), which varies the voltage V_{S} on buffering capacitor 48 while keeping V_{S} within a desired range, corresponding to the predefined range over which the charge on the buffering capacitor is permitted to vary. (This functionality is described further hereinbelow with reference to FIGS. 3A/B.)

Control circuit 50 comprises digital logic circuitry for carrying out the control functions that are described herein, together with suitable sensors for measuring voltages and currents in switched power converter 32 and driver circuits for controlling switches 38 and 40. Some of these components of control circuit 50 are described further hereinbelow with reference to the figures that follow. The digital logic circuitry may comprise hard-wired or programmable logic components. Alternatively or additionally, at least some of the functions of the digital logic circuitry may be implemented by a programmable processor under the control of suitable software or firmware.

Reference is now made to FIGS. 3A and 3B, which schematically illustrate aspects of the operation of PnP VIC 22, and particularly of control circuit 50, in accordance with an embodiment of the invention. FIG. 3A is a plot of the voltage V between terminals 31 against the charge on buffering capacitor 48, showing the operating ranges of the PnP VIC. FIG. 3B is a state machine model implemented by control circuit 50 in controlling switching circuitry 36, in response to the charge on buffering capacitor 48 (indicated by the voltage V_{S}, as noted above).

As shown in FIG. 3A, the operation of PnP VIC 22 is governed according to a predefined range of the charge Q on buffering capacitor 48, between the minimum and maximum values Qₘᵢₙ and Qₘₐₓ. When Q is within this range, the PnP VIC is able to maintain the voltage V between terminals 31 at the reference level Vᵣ notwithstanding changes in the charge, and thus exhibits effectively infinite capacitance, meaning that dV/dQ=0. PnP VIC 22 has three regions of operation in relation to this charge range:
A low-charge range 52, in which Q<Qₘᵢₙ, which is encountered mainly in the course of powering up system 20. Qₘᵢₙ is the minimum charge needed on buffering capacitor 48 to reach the voltage V_{S} at which switched power converter 32 can operate properly.
A normal charge range 54, between Qₘᵢₙ and Qₘₐₓ, as explained above.
An overcharge range 56, in which buffering capacitor 48 and switches 38 and 40 must be protected from excessive voltage. In this range, switches 38 and 40 are opened, so that only filtering capacitor 34 is connected between terminals 31, and the voltage control function of PnP VIC 22 is disabled.
   The types and capacitance of capacitors 34 and 48, as well as other components of switched power circuit 32, are typically chosen depending on the characteristics of system 20, so that excursions outside normal charge range 54 will occur infrequently if at all.

The states of the state machine that is shown in FIG. 3B corresponding to the operating ranges of FIG. 3A:
Initially, before and upon power-up, the voltage V between terminals 31 is too low to operate control circuit 50, so that PnP VIC 22 is in an idle state 60.
Once V has passed a certain minimal level, control circuit 50 enters a charging state 62, in which switches 38 and 40 are opened and closed alternately according to a PWM algorithm, so that the current flowing through terminals 31 charges buffering capacitor 48, until the charge on the capacitor has reached the value Qₘᵢₙ.
Within normal charge range 54, control circuit 50 maintains a normal operating state 64, in which it opens and closes switches 38 and 40 (for example, using PWM at a suitable frequency and duty cycle) to charge and discharge buffering capacitor 48, while maintaining the voltage V between terminals 31 at the reference voltage value Vᵣ.
When the charge on buffering capacitor 48 exceeds Qₘₐₓ, control circuit 50 enters a protection state, in which switches 38 and 40 are opened to prevent overcharging. In this state, buffering capacitor 48 maintains a constant, maximal value of V_{S,max}.

Control circuit 50 makes transitions between states 62, 64 and 66 in response to changes in the charge (and thus the voltage V_{S}) on buffering capacitor 48. To prevent rapid oscillation between states, control circuit 50 applies a hysteresis to the levels of the charge on the buffering capacitor that cause transitions between the states. Thus, for example, the transition from state 62 to state 64 will occur at a higher value of V_{S} than the opposite transition from state 64 to state 62.

By appropriate choice of the components of switched power circuit 32 and design of control circuit 50, the output impedance of PnP VIC 22 between terminals 31 in normal operating state 64 will be very small over the range of frequencies in which ripple is of concern, for example 50-1000 Hz. In an example design for this purpose, capacitors 34 and 48 may comprise ceramic or film components with values in the range of 10-100 μF, for instance, while inductor 46 has a value in the range of 50-200 μH. Designs of control circuit 50 that can be used in achieving the desired behavior are described further hereinbelow. When appropriately configured and controlled, PnP VIC 22 in state 64 will effectively eliminate ripple on bus 26 within the frequency range of interest. At higher and lower frequencies, the output impedance of the PnP VIC will be similar to that of a small capacitor.

### Charge Control by Updating Reference Voltage

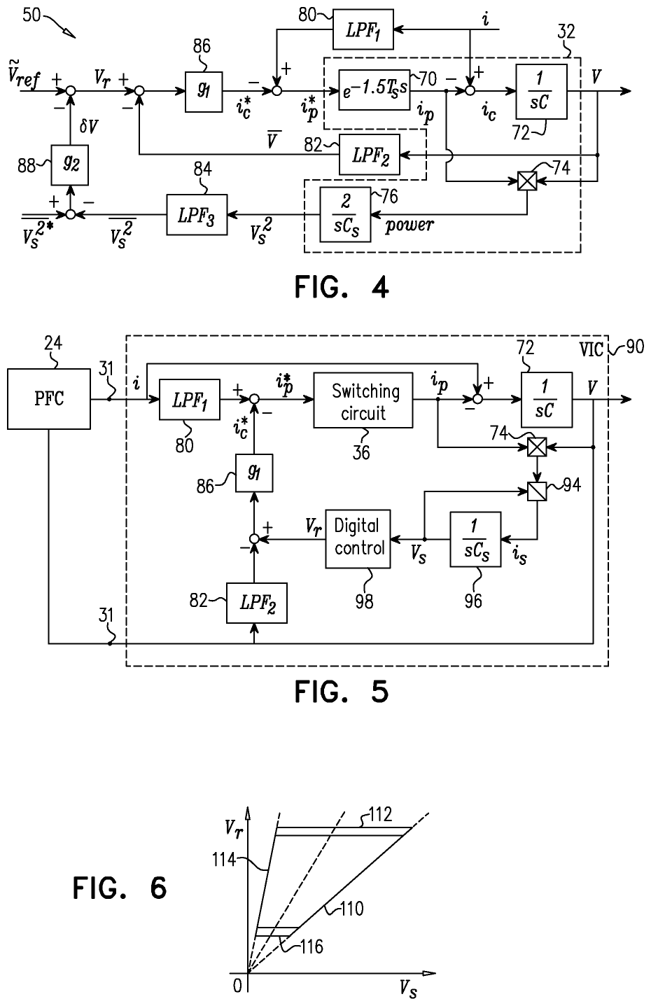

FIG. 4 is a block diagram that schematically shows details of control circuit 50, in accordance with an embodiment of the invention. In this embodiment, the control circuit monitors the buffer voltage V_{S} on buffering capacitor 48, and adjusts the internal reference voltage Vᵣ in response to changes in the buffer voltage. This feature of the control circuit is useful in adapting the reference voltage to the actual, equilibrium value V₀ of the DC voltage V on bus 26 and in maintaining the charge on buffering capacitor 48 within normal charge range 54.

For the purposes of FIG. 4, switched power converter 32 is represented in terms of its filtering properties: Given the delays inherent in the control loop and PWM operation, switching circuitry 36 is represented by a delay block 70, with a delay time of 1.5 T_{S}, wherein T_{S} is the sampling period of control circuit 50. Filtering capacitor 34 is represented as an integrator 72, which integrates the current i_{C} to give the voltage V between terminals 31. The current i flowing through the terminals is divided between i_{C} and i_{P}, i.e., i=i_{C}+i_{P}. A multiplier 74 provides the power input V*i_{P} to buffering capacitor 48, which acts like an integrator 76, giving the square voltage value V_{S}² (proportional to the stored energy in this capacitor 48).

Control circuit 50 measures the current i and the voltage Vas digital values using respective sensors 80 and 82, which are represented as low-pass filters (LPF₁ and LPF₂). Control circuit 50 applies a controller transfer function (g₁) 86 in computing a reference current value i_{C}* based on the difference between the voltage measured by sensor 82 and the reference voltage Vᵣ (which is initially set to a certain reference voltage level \tilde{V}_{ref} and is adjusted thereafter by control circuit 50). Control circuit 50 drives switching circuitry 36 with a PWM signal based on the reference current value i_{P}*, which is computed by subtracting i_{C}* from the actual current measured by sensor 80.

The reference voltage Vᵣ is adjusted by a charge control loop in control circuit 50, comprising a voltage sensor with a low-pass filter (LPF₃) 84. This charge control loop operates even when the charge on buffering capacitor is outside normal charge range 54. Sensor and low-pass filter 84 measure the buffer voltage V_{S} on buffering capacitor 48 while filtering out variations above a predefined cutoff frequency, thus giving an averaged value V̅_̅{̅S̅}̅²̅. LPF₃ typically has a much narrower bandwidth than LPF₁ and LPF₂, for instance, 30 Hz. This low pass filter LPF₃ may be of high order, and may work at a lower sampling rate than the other components of the controller 50, in order to avoid numerical problems.

Control circuit 50 subtracts V̅_̅{̅S̅}̅²̅ from a reference value V̅_̅{̅S̅}̅²̅* and inputs the difference to a transfer function (g₂) 88 to generate a voltage correction δV. The control circuit subtracts this correction δV from the current value of \tilde{V}_{ref} to generate the adjusted reference voltage Vᵣ for input to voltage controller transfer function (g₁) 86. The inner control loop, which adjusts the actual voltage V between terminals 31, has a wider bandwidth than LPF₃, so that V will closely track the adjusted reference value of Vᵣ. The process of adjustment will continue until the averaged value V̅_̅{̅S̅}̅²̅ stabilizes at its reference value V̅_̅{̅S̅}̅²̅*, at which point V=Vᵣ=V₀, which is the equilibrium voltage on bus 26.

### Charge Control Using Asymmetric Backlash

FIG. 5 is a block diagram that schematically illustrates a PnP VIC 90, in accordance with another embodiment of the invention. PnP VIC 90 is similar in structure and operation to PnP VIC 22, as shown in the previous figures and described above; and elements of similar functionality are therefore labeled in FIG. 5 with the same indicator numbers as in the preceding embodiments. In this embodiment, however, a digital control circuit 98 adjusts the reference voltage Vᵣ by applying an asymmetric backlash function to the changes in the buffer voltage V_{S} on buffering capacitor 48.

The input to digital control circuit 98 is the present value of the buffer voltage V_{S}. The block diagram in FIG. 5 represents some of the physical processes taking place in the circuit: Multiplier 74 provides the power input V*i_{P} to a divider 94, which divides the power by V_{S} to give the buffer current i_{S}. (The multiplier and the divider and not part of the control algorithm, but rather are representations of physical processes.) Similarly, buffer capacitor 48 in this case is represented as an integrator 96, which integrates the buffer current and divides by C_{S} to give the value of V_{S} for input to control circuit 98.

FIG. 6 is a plot of Vᵣ against Vₛ, showing the asymmetric backlash function that is applied by control circuit 98 in adjusting Vᵣ, in accordance with an embodiment of the invention. The backlash function comprises a large number of horizontal segments, such as segments 112 and 116, over which Vᵣ remains constant notwithstanding changes in V_{S}, and two sloped segments 110 and 114, on which Vᵣ changes rapidly with changes in V_{S}.

Control circuit 98 works as follows: The voltage control loop of PnP VIC 90 has a large bandwidth, as explained above, and thus the voltage V between terminals 31 will closely track Vᵣ. Therefore, on horizontal segments such as segments 112 and 116, where Vᵣ is constant, the ripple in V will be small, as desired. If V is smaller than the equilibrium voltage V₀, however, more current i will continue flowing into PnP VIC 90, thus increasing V_{S} and pushing the operating point (V_{S}, Vᵣ) from segment 116 onto segment 110. As V_{S} increases further along segment 110, Vᵣ will also increase until it reaches its maximum value on segment 112. Likewise, as V_{S} decreases along segment 112, (V_{S}, Vᵣ) will reach segment 114, along which Vᵣ will decrease as V_{S} continues to drop.

Although the parameters of the asymmetric backlash function of FIG. 6 may be held fixed, in some embodiments control circuit 98 dynamically modifies the width of the asymmetric backlash function, i.e., the slopes of the lines corresponding to segments 110 and 114. For example, the width may be modified in response to the swing range of the changes in the buffer voltage V_{S}. Thus, if the ripple in the voltage V is large, causing a large swing in V_{S}, then the lengths of the horizontal segments, such as segments 112 and 116, will increase accordingly, up to a maximum dictated by the limitations of the circuitry.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for controlling DC voltage on a bus, comprising:
a switched power converter, comprising:
a pair of terminals for connection between the bus and a ground;
a buffering capacitor; and
switching circuitry coupled between the buffering capacitor and the terminals and configured to control a voltage between the terminals while a charge on the buffering capacitor varies over a predefined range in response to a current flowing through the terminals; and
a control circuit, which is coupled to monitor the voltage between the terminals, the current, and a voltage on the buffering capacitor, and is configured to adjust the voltage between the terminals by controlling the switching circuitry in response to changes in the monitored voltages and current so that the terminal voltage is maintained at a reference voltage value.

2. The apparatus according to claim 1, wherein the switched power circuit comprises a filtering capacitor coupled between the terminals.

3. The apparatus according to claim 1, wherein the switching circuitry comprises diodes and switches, which are configured as a reversible buck converter circuit.

4. The apparatus according to claim 1, wherein the control circuit is configured to control the switching circuitry by applying a state machine model comprising:
a charging state, in which the current flowing through the terminals, after conversion by the power converter, charges the buffering capacitor;
a normal operating state, in which the switching circuitry is controlled to charge and discharge the buffering capacitor while maintaining the voltage between the terminals at the reference voltage value; and
a protection state, in which the switching circuitry is opened to prevent overcharging of the buffering capacitor.

5. The apparatus according to claim 4, wherein the state machine model includes a hysteresis in levels of the charge on the buffering capacitor that cause transitions between the states.

6. The apparatus according to claim 1, wherein the control circuit is configured to control the switching circuitry so as to maintain the charge on the buffering capacitor within the predefined range.

7. The apparatus according to claim 6, wherein the control circuit is configured to adjust the reference voltage value responsively to changes in the buffer voltage so as to maintain the charge on the buffering capacitor within the predefined range.

8. The apparatus according to claim 7, wherein the control circuit comprises a voltage sensor and a low-pass filter, which couples the voltage sensor to measure the buffer voltage on the buffering capacitor while filtering out of the measured buffer voltage variations above a predefined cutoff frequency, and wherein the control circuit is configured to adjust the reference voltage value responsively to the measured, filtered buffer voltage.

9. The apparatus according to claim 7, wherein the control circuit is configured to adjust the reference voltage value by applying an asymmetric backlash function to the changes in the voltage on the buffering capacitor.

10. The apparatus according to claim 9, wherein the control circuit is configured to modify a width of the asymmetric backlash function responsively to a swing range of the changes in the buffer voltage.

11. A method for controlling DC voltage on a bus, comprising:
coupling a pair of terminals of a switched power converter between the bus and a ground, the switched power circuit comprising:
a buffering capacitor; and
switching circuitry coupled between the buffering capacitor and the terminals and configured to maintain a voltage between the terminals at a reference voltage value while a charge on the buffering capacitor varies over a predefined range in response to a current flowing through the terminals;
monitoring the voltage between the terminals and the current flowing through the terminals; and
adjusting the voltage between the terminals by controlling the switching circuitry in response to changes in the monitored voltage and current so that the voltage is maintained at the reference voltage value.

12. The method according to claim 11, wherein the switched power circuit comprises a filtering capacitor coupled between the terminals.

13. The method according to claim 11, wherein the switching circuitry comprises diodes and switches, which are configured as a reversible buck converter circuit.

14. The method according to claim 11, wherein controlling the switching circuitry comprises applying a state machine model comprising:
a charging state, in which the current flowing through the terminals, after power conversion, charges the buffering capacitor;
a normal operating state, in which the switching circuitry is controlled to charge and discharge the buffering capacitor while maintaining the voltage between the terminals at the reference voltage value; and
a protection state, in which the switching circuitry is opened to prevent overcharging of the buffering capacitor.

15. The method according to claim 14, wherein the state machine model includes a hysteresis in levels of the charge on the buffering capacitor that cause transitions between the states.

16. The method according to claim 11, wherein the switching circuitry is controlled so as to maintain the charge on the buffering capacitor within the predefined range.

17. The method according to claim 16, wherein controlling the switching circuitry comprises monitoring a buffer voltage on the buffering capacitor, and adjusting the reference voltage value responsively to changes in the buffer voltage so as to maintain the charge on the buffering capacitor within the predefined range.

18. The method according to claim 17, wherein controlling the switching circuitry comprises measuring the buffer voltage on the buffering capacitor while filtering out of the measured buffer voltage variations above a predefined cutoff frequency, and adjusting the reference voltage value responsively to the measured, filtered buffer voltage.

19. The method according to claim 17, wherein controlling the switching circuitry comprises adjusting the reference voltage value by applying an asymmetric backlash function to the changes in the buffer voltage.

20. The method according to claim 19, wherein applying the asymmetric backlash function comprises modifying a width of the asymmetric backlash function responsively to a swing range of the changes in the buffer voltage.
